(19) United States
(12) Patent Application Publication
(10) Pub. No.: US 2023/0005006 A1
(43) Pub. Date: Jan. 5, 2023

(54) GAMING OFFER GENERATION VIA RULES-BASED ENGINE

(71) Applicant: OPTX Solutions, LLC, Las Vegas, NV (US)

(72) Inventors: Ashley Brooke Fiumara, Las Vegas, NV (US); William Warner, Las Vegas, NV (US); Thomas Rafferty, Las Vegas, NV (US)

(21) Appl. No.: 17/364,272

(22) Filed: Jun. 30, 2021

(51) Int. Cl. G06Q 30/02

(52) U.S. Cl. CPC G06Q 30/0224; G06Q 30/0236; G06Q 30/0269; G06Q 30/0261; G06Q 30/0239

(57) ABSTRACT

Systems and methods for generating offers can utilize a rules-based engine using received player information and a set of rules associated with at least one merchant. A subset of the rules can be based on the player information and the set of play preferences. An offer can be generated based on the set of applicable rules, and the offer can be redeemed at a merchant location, which can be a physical location, e.g., a casino, or online gaming platform.

### BACKGROUND

Casinos and merchants in the gaming industry compete to attract customers, and often incentivize potential customers and players through gaming credits and free play offers. Gaming credits, for example, may provide a player a certain amount money that can be spent at a particular location, on a certain type of game(s), etc. Free play offers are similar and can allow a player a certain number of plays, attempts, turns, etc., for a particular game, event, betting event, and the like. Such incentives may be used to target certain customers, incentivize particular games, merchant locations, a time of play, and so forth.

As such, customers and players may be eligible for multiple offers, and various amounts of free play and/or gaming credit based on the merchant, a location, a day/time, a type of game, etc. Customers and gamers are therefore incentivized to weigh various offers and select the best one that aligns with their gaming interests and goals. However, it can be difficult and time consuming for players to identify available offers for which they qualify. In some scenarios, players may have to contact different casinos and merchants to identify any available offers. In others, players might be provided with the offer directly through a merchant's rewards program, player account, upon check in at a location, or other means. There is currently no efficient or convenient means to identify and weigh available offers.

From the casino and gaming merchants' perspective, there is a similar challenge in efficiently and profitably providing offers and incentives, such as gaming credits and/or free play to eligible customers. This can lead to further challenges, even an inability, for casinos and merchants to efficiently compete with each other using offers and incentives, since customer visibility is limited. Accordingly, there is a need for an efficient, streamlined approach to optimize available opportunities and communicate such offers between gaming merchants and potential players.

### SUMMARY

Disclosed herein are systems and methods for generating gaming offers. Embodiments can comprise a secure cloud database storing player information, including play preferences, for at least one user, and rules associated with one or more merchants; and a processor in communication with at least one memory, the memory comprising instructions that cause the processor to at least: receive player information, including a set of play preferences associated with a user; receive information indicative of a set of rules, each rule associated with at least one merchant; determine a subset of applicable rules based on the player information and the set of play preferences; generate an offer based on the subset of applicable rules, wherein the offer is redeemable at a merchant location; and output the at least one offer on a user interface.

In various embodiments, the offer provides a free play amount for redemption at the merchant location, such as a physical location or an online gaming platform. Play preferences can include but are not limited to a type of game, a frequency of play, a preferred type of play, a budget, a date of play, and a time of play. The preferred type of play can be based on a budget or a time range for play.

In other embodiments, a subset of the offer rules is defined by the merchant. In an example, at least one rule in the set of applicable rules provides a free play amount based on the anticipated budget. In another example, the player information includes a player rating, and at least one rule in the set of applicable rules provides a free play amount based on the player rating. The player rating can be based on at least one of: a player history, an offer redemption history, an amount spent, and criteria set by the merchant.

In additional embodiments, a determination regarding offer redemption is made, and the player information is updated with redemption information. Redemption information may be applicable to one or more rules in subsequent offers. Embodiments also include determining a player rating based on the player information and updating the subset of applicable rules based on the player rating. At least one rule can determine a free play amount based on player history with the merchant. At least one rule can determine a free play amount based on player history with the merchant.

In various embodiments, the offer is redeemable via at least one of: a QR code, an alphanumeric code, an email, a text message, a printable coupon, and an update to a player account associated with the merchant. More than one offer can be generated through the systems and methods discussed herein, at one or more merchants and merchant locations.

Other features and advantages of the invention will be apparent from the detailed description that follows.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 illustrates an example architecture for connecting players and gaming merchants, to identify and match potential offers, in accordance with various embodiments discussed herein.

FIG. 2A illustrates an example user interface to log in or create a player account in accordance with embodiments.

FIG. 2B illustrates an example user interface to select a location in accordance with embodiments.

FIG. 3A illustrates an example user interface to select a gaming location in accordance with embodiments.

FIG. 3B illustrates an example user interface to set preferred gaming locations accordance with embodiments.

FIG. 4A illustrates an example user interface to set player gaming preferences in accordance with embodiments.

FIG. 4B illustrates an example user interface to select additional game preferences in accordance with embodiments.

FIG. 5 illustrates an example user interface to upload offers in accordance with embodiments.

FIG. 6A illustrates an example user interface displaying a user dashboard in accordance with embodiments.

FIG. 6B illustrates an example user interface displaying an offer in accordance with embodiments.

FIG. 7 illustrates an example flowchart for offer generation in accordance with embodiments.

FIG. 8 is a diagram further illustrating offer generation in accordance with embodiments.

FIG. 9 illustrates an example flowchart regarding offer generation from a user perspective.

FIG. 10 illustrates a cloud computing system in accordance with embodiments.

FIG. 11 shows an example computing device which may be used to perform any of the techniques disclosed herein.

### DETAILED DESCRIPTION

The present systems and methods relate to systems and methods for generating gaming offers. Embodiments of the present invention comprise a computing device in secure communication with a database, wherein the computing device comprises a processor, and at least one memory communicatively coupled to the processor, the memory comprising instructions that cause the processor to at least: receive player information, including a set of play preferences associated with a user; receive information indicative of a set of rules, each rule associated with at least one merchant; determine a subset of applicable rules based on the player information and the set of play preferences; generate an offer based on the subset of applicable rules, wherein the offer is redeemable at a merchant location; and output the at least one offer on a user interface.

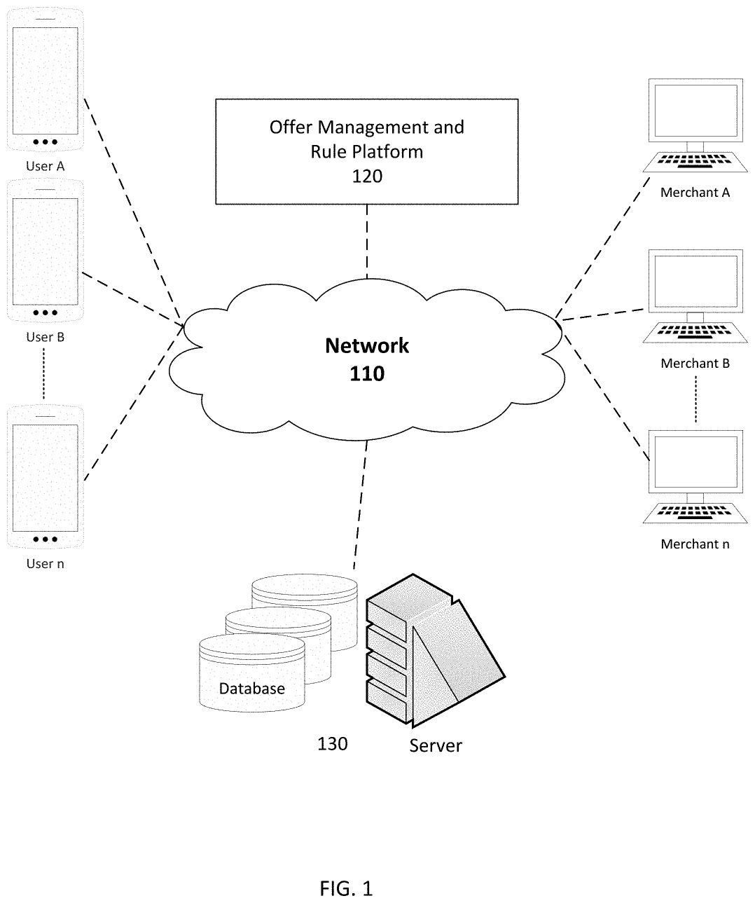

FIG. 1 illustrates an example architecture for connecting players and gaming merchants, to identify and match potential offers, in accordance with various embodiments discussed herein. In an example, a user computing device can execute an application connecting the device to a network in communication with one or more servers and databases, usable to identify available offers. In embodiments, the user computing device can be a mobile computing device, such as a smartphone, tablet, or other computing device, such as a desktop computer.

Through an application on the user computing device, information indicative of player information and one or more play preferences can be submitted. Such information and play preferences can include at least one or more of a desired merchant, location of play, preferred games, player account information, and anticipated dates, times, budget, and type of play.

A plurality of merchants, e.g., Merchants A, B, n, can be connected to a common network 110 and provide one or more rules, usable to generate offers at an offer management and rule platform 120. As discussed in detail below, rules can be configured by merchants to attract players to play at a merchant location. The rules can be tailored, for example, to attract players to a certain game, time, or location of play, to incentivize users anticipating spending various amounts for play, and generally target a diverse range of players.

The offer management and rules platform 120 receives player information, e.g., User A, B, . . . , n, including but not limited to player preferences and anticipated play information, as well as information from one or more merchants regarding rules for offers (e.g., offer $X amount of free play, for players anticipating spending $Y amount on a particular date), and analyzes the received information via a rules engine to generate one or more offers to the player.

In embodiments, received player information, merchant information, merchant rules and preferences, offer history, including offer redemption history, player behavior, player ratings, and the various types of information utilized by the disclosed systems and methods discussed herein, can be stored in a database 130 accessible by the offer management and rules platform 120 via network 110.

In various embodiments, additional player history can be obtained from a merchant, e.g., from a particular casino or location, stored at database 130, and/or used for analysis and offer generation at platform 120. The obtained player history can be used as discussed herein, and in some cases, can provide additional detailed player information for tailored offers.

Such additional player information can include, but is not limited to: a play pattern, a frequency of play (daily, monthly, etc.), a visit frequency, a type of play, e.g., based on budget, time, etc., a typical budget amount, a User ID, favorite games, previous offers, redeemed offers, most frequented locations, and the like.

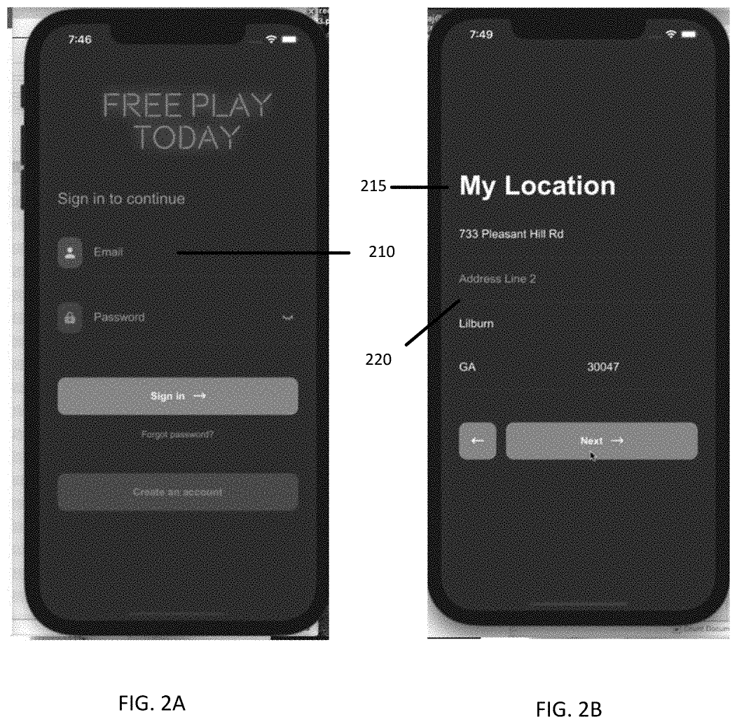

Information requested from Users, i.e., Players, can be obtained a user interface, as discussed in FIGS. 2-6. The information requested and received from the one or more merchants may also be entered in via an application displayed on a user interface of a computing device, and can come in any of a variety of files, methods, and formats. For example, the information can be provided via an online form, sent as a flat file, a spreadsheet, sent via a direct connection, obtained through a shared database, use of a VPN, direct access to casino programs and databases, and the like.

FIG. 2A illustrates an embodiment of the present invention enabling a user to create or log in to an account. Both merchants, e.g., casinos, and players can create an account to log in. A user can sign up for an account 210 by entering one or more of an email, username, name, password, and other account identifying information. In embodiments, users can information such as one or more of a user name, a date of birth, and a photo. A date of birth may be required to verify an age, e.g., for compliance, or to prohibit use of the service for users under a certain age. In examples, users can use a face recognition technology, e.g., FACE ID, a social media login, e.g., FACEBOOK, an email account, e.g., GOOGLE, or other online account to log in and access an account.

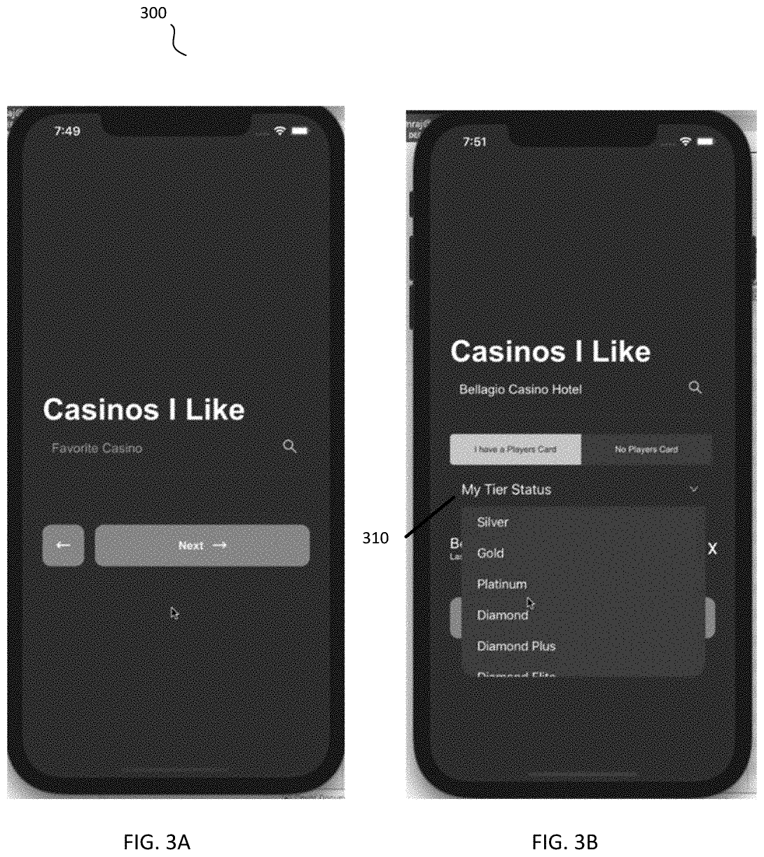

FIG. 2B illustrates a request for location information 215. In examples, the location can be a user address 220, a casino or merchant address, an address or location where a player desires to play or will be visiting, and/or a location of interest to the user. As seen in FIGS. 3A-3B, a user can identify at least one merchant, e.g., casino, of interest, such as a favorite location, or location where they will be playing or would like to play at.

In examples, upon selecting a favorite casino on the interface of FIG. 3A, a user will be brought to the interface of FIG. 3B and asked additional information. FIG. 3B provides an interface to enter player information regarding a preference for a particular location 300 selected in FIG. 3A. Such additional information can include, but is not limited to, whether a user has a player card or player account at the particular location, and if applicable, a tier status 310 for that player account, e.g., Silver, Gold, Platinum, Diamond, Diamond Plus, Diamond Elite, or other designations associated with player accounts for a selected location

In embodiments, users can be asked to provide, e.g., upload, a photo of an applicable player card or similar indication of a player account. The information can be used to link an account and/or verify that the user has played the location before. In embodiments, the previous player indication may be used to identify and/or verify particular offers for which the user qualifies. For example, certain offers may provide a first amount of credit or free play for new players, and a second amount of credit or free play for players who have previously played at a location. The first amount can be higher or lower than the second amount. In some examples, the first and second amount are the same.

In addition, the player card and/or player account information can further be used to collect information about a particular user, and users in general. For example, player information can be collected and used, in the aggregate, to identify popular casinos, merchants of interests, locations with the highest interest, and the like.

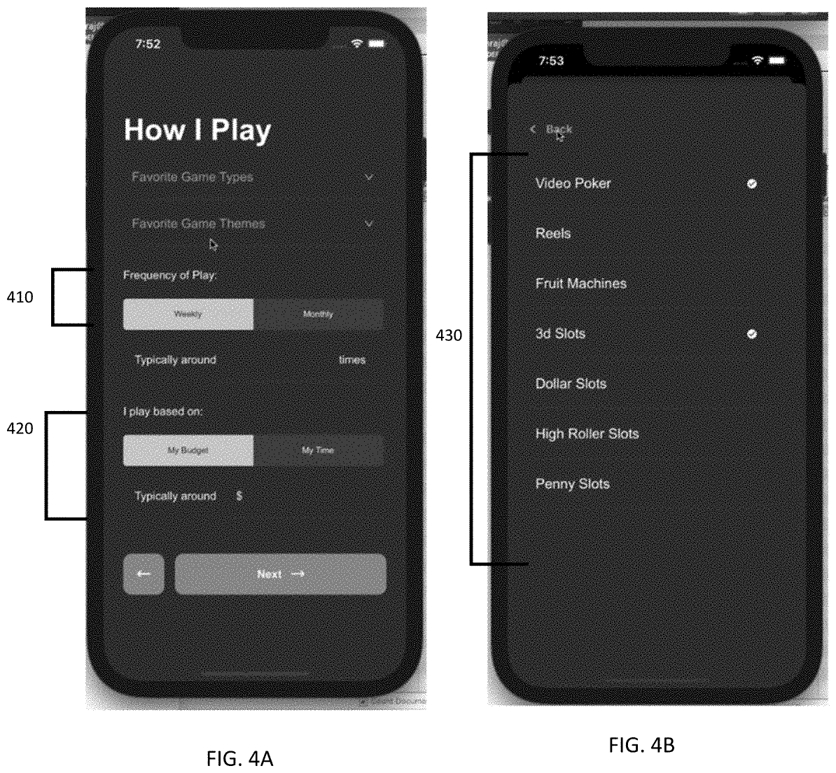

FIGS. 4A-4B illustrate the collection of information regarding a preferred and/or anticipated type of play for a user. As seen in FIG. 4A, users can identify, for example a frequency of play 410 (e.g., weekly, monthly), and a basis of play 420 (e.g., budget or time). With regard to the basis of play, a budget basis indicates that a budget is a primary factor for the player, and in examples, the player can indicate their anticipated or desired budget. A time basis indicates that time is a primary factor for the player and in examples, the player can indicate their anticipated or desired length of time for play, and particular dates for play, including specific days of the weeks, or times of day.

Players can optionally indicate favorite game 430 types and/or favorite game themes. Such information may be used, in embodiments, to identify and/or tailor certain gaming offers to a user. FIG. 4B illustrates a non-exhaustive list of potential selections that can be made for a Favorite Game Type. Such games can include, but are not limited to, video poker, reels, fruit machines, slot machines, 3D slots, dollar slots, high roller slots, and penny slots. In embodiments, users can enter in additional games. In other embodiments, the games available for selection may be tailored based on one or more previous selections or user information entered. For example, the game selection can be limited to games available at a selected casino, merchant, location, user preference, and the like. In addition, the play information can be used to collect information about the player, in general, and/or be used to collect information and identify insights regarding a plurality of users, as discussed herein

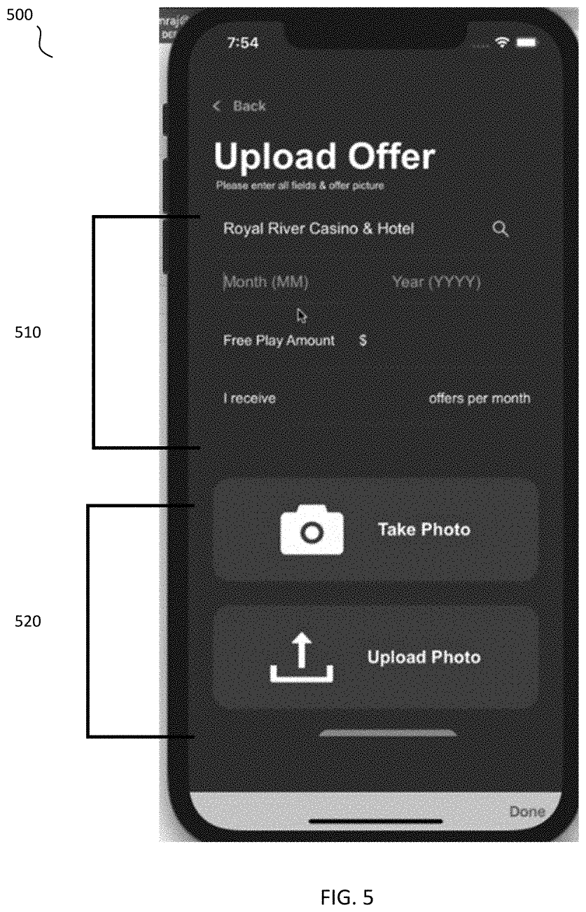

FIG. 5 illustrates a collection of information regarding received offers 500. In examples, a player may have received an offer from a particular merchant, for a particular location, or other source. In examples, the offers can be printed offers, electronic offers, or offers received through other means. Such offer information can be collected 510 through the user interface and may optionally be applied to identify and/or tailor offers to the user. If a current offer is available, information about the offer can be requested. Such information can include, but is not limited to a location of the offer, an expiration date, and month and/or year for which the offer is valid, an amount of free play offered, and a frequency indicative of how often the type of offer is received, e.g., X offers per month. In embodiments, the user interface can provide an option for a user to take a photo of the offer 520, or for a user to upload a photo of the offer. In embodiments, the uploaded photo may be used to verify one or more details of the offer. In other embodiments, the image can be used to identify and/or auto-populate details of the offer. As discussed herein, the information can be used to acquire general player information and/or used to collect information about a plurality of players, e.g., to further tailor and optimize offer matching.

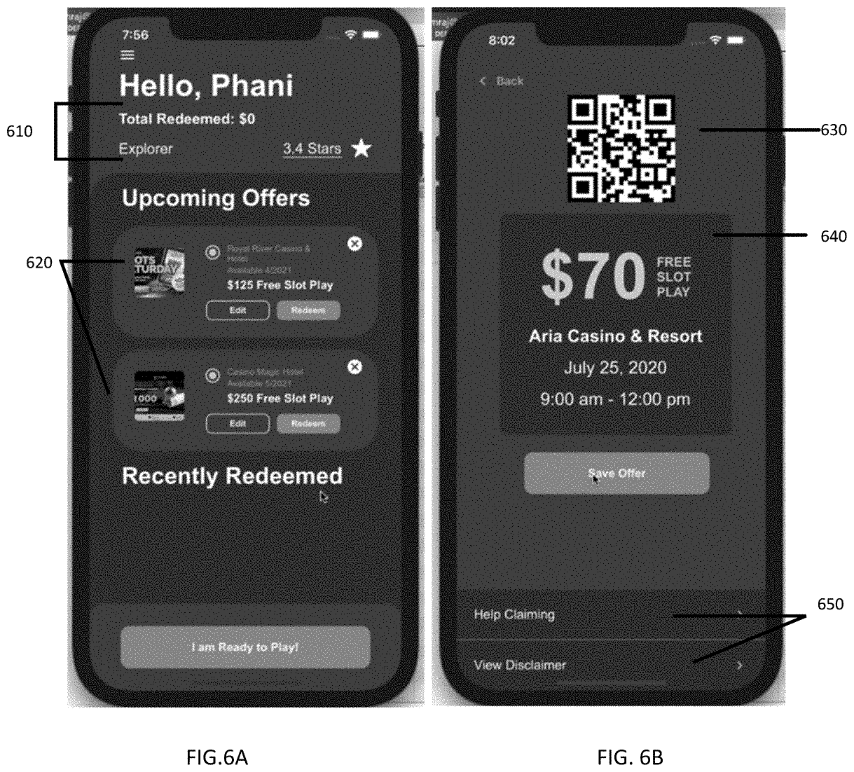

FIGS. 6A-6B respectively illustrate a user dashboard and an offer. In embodiments, the user dashboard lists any upcoming offers provided to the user. A history of recently redeemed offers can optionally be listed. As seen in FIG. 6A, the upcoming offers page can provide a brief summary of one or more available offers, and list information including but not limited to a value amount of the offer, a location where the offer is valid, and one or more selections for a user to edit the offer or redeem the offer. In embodiments, the display order of the offers can be changed based on user preference. Likewise, offers can be removed or hidden from view. Offers can further be customized with a picture or logo to be associated with the offer.

The offer dashboard can be dynamically updated as the user updates information, e.g., changes a desired location of play or a time of play, and the offers can be updated as well. In embodiments, users can select a location for play, e.g., by entering a city name or zip code. Other embodiments allow options for both online and land-based casinos. In other words, users can have the option to select a particular city/physical location or indicate that online play is desired. The systems and methods discussed herein, with respect to merchants fully apply to online merchants and online gaming platforms.

The user dashboard can further comprise a summary 610 regarding the user's activity. The user activity summary can indicate a total value amount redeemed by the user, such as a total cash value amount redeemed. A user rating, e.g., 3.4 Stars, and a user categorization, e.g., “Explorer,” can be listed to provide additional information about the user.

Selecting an offer 620 can provide additional information about the offer, as illustrated in FIG. 6B. Additional offer details 640, such as the value of the offer, the type of play associated with the offer, the location, date, valid time or time range for the offer, and a QR code 630 to redeem the offer, can be displayed on the user interface. In embodiments, users have an option to save the offer, e.g., for later viewing, for offline viewing, and the like. Additional support features 650 can also be provided. Such features can include an option for help in claiming the offer, and viewing disclaimers, terms, and/or conditions regarding the offer. Embodiments may include an option to save the offer in a separate application, such as an APPLE wallet, print the offer, email, text, or otherwise send the offer to a different application.

In various embodiments, players can only accept one offer per time period. Players may have multiple offers saved, but not multiple offers that overlap for any period of time. Players can switch offers by un-canceling an accepted offer and selecting a new offer.

Offers may be redeemed at their given location by presenting the offer on the user interface. At a redeemable location, an offer can be redeemed, for example, at a kiosk, at a player's club desk, at a particular casino location, or otherwise, by scanning a QR code, entering an alphanumeric code, or entering an identifier associated with offer. In some embodiments, the offer can be loaded to a player card or a player account for a specific location. The communication of the offer to the user account can occur, for example, automatically, upon acceptance of the offer, when verified at a particular location, and the like. Similarly, the offer can be removed from the player account if the player cancels the offer, e.g., to accept a different offer.

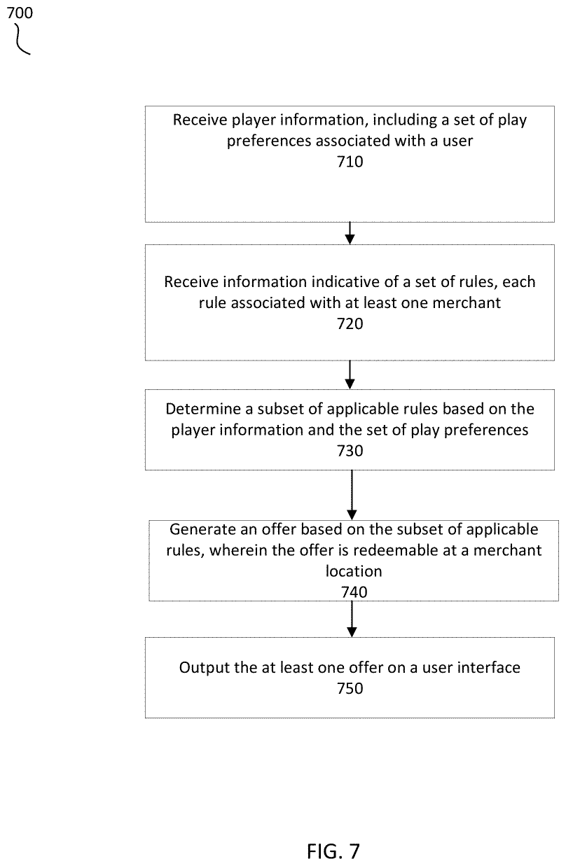

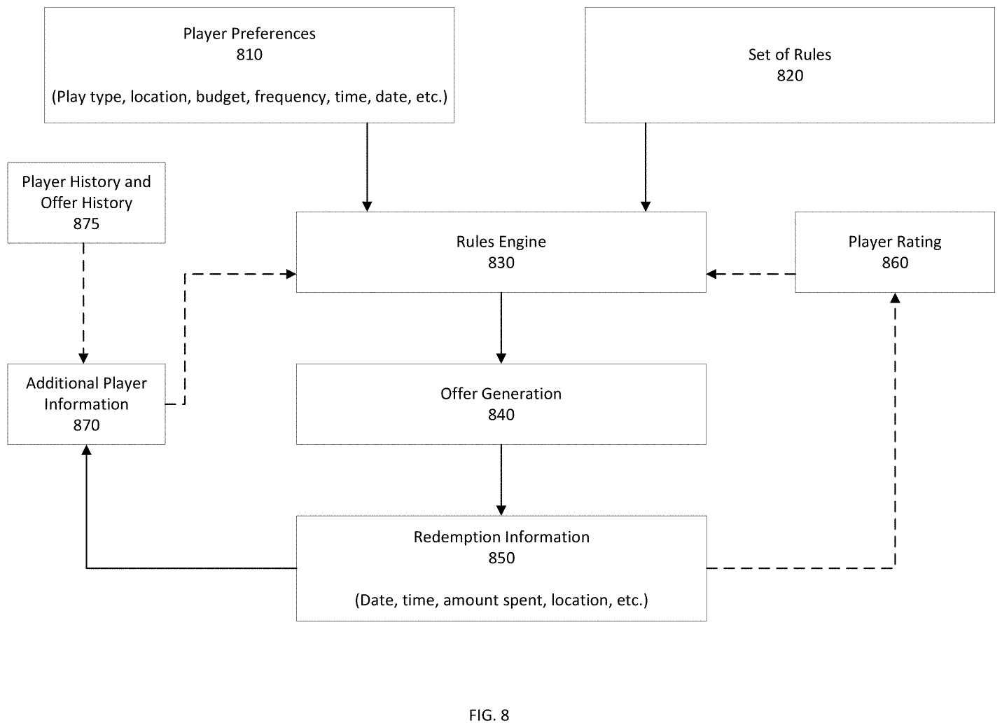

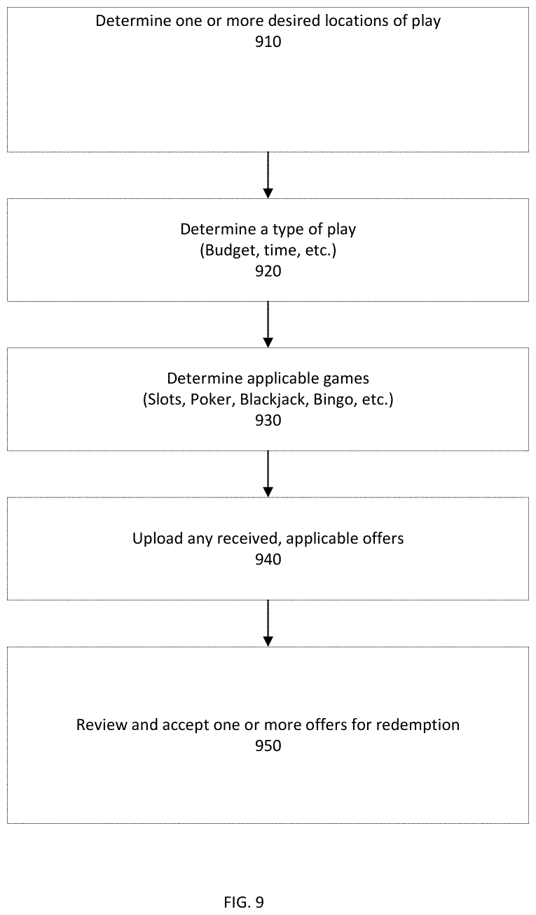

FIG. 7 depicts a flowchart illustrating an example method for offer generation. The relationship between datasets are further illustrated in the diagram of FIG. 8, and offer generation from the user perspective is illustrated in FIG. 9

Embodiments of the present invention can comprise a rules engine that receives information indicative of play preferences 710, 810 information indicative of one or more rules 720, 820. Each rule in the set of rules is associated with at least one merchant. Then, a subset of applicable rules is determined based on the player information and the set of play preferences 730. In embodiments, a rules engine 830 manages the data analysis and offer generation.

An offer for play is generated 740, 840 based on the received information, i.e., the subset of applicable rules, and output on a user interface 750, e.g., an interface of a mobile computing device. In embodiments, the offer is redeemable at one or more merchant locations. Players can submit the play preferences and merchants can define one or more rules. Merchants can enter, edit, remove, and/or update requirements for offers, based on preference, business reasons, and the like.

In various embodiments, offers can be generated based on one or more play preferences. The play preferences can be submitted through a user interface on a computing device, such as a mobile computing device, as discussed herein. The play preferences can include, but are not limited to, a type of game, a frequency of play, a budget, a time range for play, and a date of play, and a time of play.

In other embodiments, player history and offer history 875 can contribute to additional player information 870 that can optionally be used by the rules engine 830 in the analysis for offer generation 840. Redemption information 850, including but not limited to the date of redemption, time of redemption, amount spent that visit, a location of redemption, and the like, can be stored as additional player information 870 for subsequent offer generations. Such redemption information 850 can also be used to determine a player rating 860, as discussed further below, and optionally usable by the rules engine 830 to generate one or more offers.

With regard to the set of rules 820, merchants, such as gaming locations and casinos, can define one or more offers each having one or more rules to be satisfied for a player to qualify for the offer. In embodiments, the offers can be static offers, dynamic offers, or a combination. In a static offer, a value of the offer may be fixed, for example, if a certain offer rule is met. In a dynamic offer, the offer is adjusted based a combination of factors, a formula, a weighted calculation based on inputs, such as play preferences, a budgeted amount, a date of play, or time of play.

FIG. 9 illustrates a flowchart regarding offer generation from a user perspective. On a user interface, such as an application on a mobile computing device, a user can determine one or more desired locations of play 910 as discussed herein. The user can further define a desired type of play 920, based on a budget, a specific date, time, or generally indicate that time is the player's typical basis of play. User selections help determine applicable games 930 for the user, including but not limited to slots, poker, blackjack, bingo, and the like. Such preferences can, in some embodiments, assist in tailoring rules and generated offers to the user. Users can optionally upload any received, applicable offers 940, as discussed herein and with respect to FIG. 5. Then, generated offers can be presented on the user interface, and users can review and accept one or more offers for redemption 950.

In an example, a player can enter an anticipated budget of money on a desired date. The rules engine can then generate offers based on at least one rule, e.g., a merchant-defined rule. For example, a rules engine can determine an offer value amount based on an anticipated budget provided by a player. The rule can determine the offered amount based on a percentage of the anticipated spending amount. The amount offered may be capped at a certain value, e.g., 10% of the player's anticipated spending amount, up to $100. The rule, e.g., one or more of the calculation, an amount offered, an offer cap, etc. may be adjusted based factors defined by the merchant, such as a date, time, or length of play, and/or a type of game, e.g., slots, blackjack, video poker, etc.

In an illustrative example, a player might indicate a budgeted or anticipated spending amount of $100 on May 1. A merchant's rule may assign 10% of the player's budgeted amount, i.e., $10, to be offered as a free play amount at the merchant's location. The rule—or an additional rule—can adjust the free play amount based on the day, e.g., offering 15% of the player's anticipated spending amount if the date falls on a Monday-Friday, if the time is a certain time of day, and any of a plurality of other factors that may be defined by the merchant. The rules engine may receive both the player and rule information and generate an offer.

Additional embodiments of the invention can provide a direct connection between the player and the merchant. The direct connection can be used, for example, to help the merchant verify player information, and assist in evaluating both the player and the offer. Such information can be used to identify player qualifications for certain offers, develop tailored offers, and gather data regarding one or more players.

In an example, an offer can be generated based on a rule that offers a certain amount of free play based on a predicted amount of money that the player is expected to win. An offer can be based on a percentage, e.g., 10%, of the user's theoretical net win, which can be based on the user's previous information, such as the actual amount or average amount of past wins within a time period, e.g., past 90 days. Again, the rules can be defined according to merchant preferences and settings. The rules engine can generate offers based on the received player information and rule information for a particular location.

In embodiments, the above offer calculations, which can use additional player information outside of the directly entered play preferences, can be implemented instead of or in addition to the examples and embodiments discussed above. The offer generation process can be fully customizable. Direct connections between merchants and players, e.g., to link a player account to receive play history and player information, as discussed herein may be optional. In embodiments, the information can be used in addition to the provided player information. Additional player information can be used to further tailor offers and identify one or more offers for which the player qualifies. In embodiments, players have the option to decide whether or not to link their accounts.

Embodiments of the present invention can further determine and utilize player ratings 860 for offer generation. This additional player information can help merchants better understand its players, identify player satisfaction, play history, and player practices. Such information can be helpful for merchants to further tailor its rules and offers to particular players, e.g., existing players or new players, certain types of players, promote certain games, dates, times of play, and the like.

In examples, players are given the option to evaluate their play experience at a particular location. Scoring can be quantitative, e.g., 1-10 rating, or qualitative, e.g., good, bad, satisfied, unsatisfied, with the requested information being fully customizable to merchants and locations. The information may be used to define one or more rules, which may, for example, be applicable only to players who rate a location a certain way, e.g., to target a subset of players, such as satisfied or unsatisfied players.

In other embodiments, merchants can also use player information and/or play history information to provide player ratings. In these examples, player ratings can be based, for example, on player history, including but not limited to whether the player showed up at the indicated time, an amount that the player spent, whether the player stayed longer or less than the assigned or anticipated play time, whether the player met his/her budget or spent more or less than anticipated, the types of games that were played, the overall profit made by the player, other offers saved, redeemed, or received by the player, and so forth.

Such metrics and ratings information can be further utilized by the rules engine to help tailor offers, analyze player offers, determine an effectiveness of offers, and compare offers from various locations.

In an example, a player's rating can be a numeral score, e.g., 1 to 5. A player's history can influence that rating, the effect being automatic and/or customizable based on one or more merchant preferences, rules, and the like. The player history can further be requested by merchant's and may be particularly useful for merchant's determining the rules to applied for offer generation.

In one example, a player anticipating a spending budget of $450 and given a $90 free play offer at a particular location, played the $90 of free play and spent no additional money. The player's behavior can be taken into account during subsequent offer generations, and offered less or nothing in the future, since the player's behavior suggests that the player's actual spending will be less than the player's anticipated amount. Conversely, in the same situation, where the player anticipates spending a certain amount, and spends significantly more than anticipated amount, the player may be considered a very profitable guest. In subsequent offers, the more profitable player may receive an additional or increased offer amount, since the player's history suggests that that player's spending matches or exceeds the anticipated amount. Player history can further be used predictively, to anticipate player behavior, identify trends, and dynamically adjust offers.

Specific aspects of the player's history and player information can be requested as well. For example, information regarding a player's prior dates or times of play, games played, and demographic information. Information regarding previous offers sent to the player and offers redeemed by the player can be communicated as well, e.g., to further understand the player and the types of offers that the player is receptive to. Each of these methods can be used to better understand the player and develop tailored offers.

Embodiments can further allow individual merchants, including specific locations of each merchant to create their own player rating/score methodology. In examples, a merchant can request a summary of play information, can be obtained directly through the player, player history information recorded at the location, through prior application use, and any of a plurality of other means.

Examples of requested information can include dates, time, and locations of play, how closely the player followed their anticipated play (e.g., location, time, games, budget, etc.), whether the player followed through on their expected play or used their redeemed offers. Ratings of the players can be determined objectively, e.g., “Did the player show up on X date?” or subjectively, e.g., 1-10 rating based on merchant-defined factors. Such information can utilize location tracking or other methods to validate player behavior.

Player rating determinations can be fully customized, weighted, and the like, based on user/merchant preferences and factors. Likewise, such information can be useful to help understand player behavior and evaluate player response against offers that were made.

Future offers can further be adjusted based on one or more rules accounting for player ratings. For example, rules can be defined to reward frequent players with additional offers. Players may obtain increased offers based on numbers of times playing at a location, e.g., $X amount for 2-10 visits, $Y amount for 11-20 visits, and $Z amount for 20+ visits, with offer amounts optionally added on to any other offers. Likewise, player ratings and behaviors can be used to determine offer cap amounts, e.g., $50-100, based on whether a player meets certain criteria.

Since players are rated progressively, i.e., ratings can change and update as additional player and play information is collected, offers and offer rules can change in response.

In embodiments, a standardized rule system can be applied to all merchants and customers. Such standardized rules system can require a same set of information from both players and merchants and apply a same set of rules for offer generation, in order to generate a standardized set of offers to players. Embodiments can allow customization, by allowing merchants to set their own rules, define types of games for offers, set offer amounts, offer limits, and the like. As such, the standardization process provides methods for various scenarios and player information to be received, and systematically analyzes and applies applicable rules to generate consistent, tailored offers for users.

Connections between systems of the present invention and casinos can optionally be performed via an application specifically for merchants, and accessible on a computing device. The application can connect with merchants, e.g., casinos, via any of the systems and methods discussed herein. The application can optionally comprise a customer usage dashboard and/or and administrative dashboard, showing a custom set of information of interest. For example, the application can identify specific player and/or aggregate player activity with the past 30 days, or any desired range of time. The application can analyze player trends, such as time of play, games played, offers claimed, and offers used. In addition, a comparison of offers can be performed, e.g., indicating how one merchants offers compare to other merchants' offers, whether they are higher or lower than similar offers or an average offer being made for particular rules. The application can help analyze current rules and offers being presented to players, as well as to help create and tailor offers for players.

In embodiments, various aspects of the present invention, can utilize a cloud-based computing network. Information received from various parties, e.g., players, merchants, etc., can be uploaded to a cloud network, e.g., AZURE cloud, AWS cloud and the like, and stored in one or more cloud databases.

Databases can organize information in any of a plurality of methods. Information can be organized by category, for example. Such categories, can include but are not limited to: play pattern, create date, upload date, frequency of play (daily, monthly, etc.), a frequency number, a type of play, (budget, time, etc.), budget amount, user ID, favorite games, offer per month, address, casino name, location, and the like.

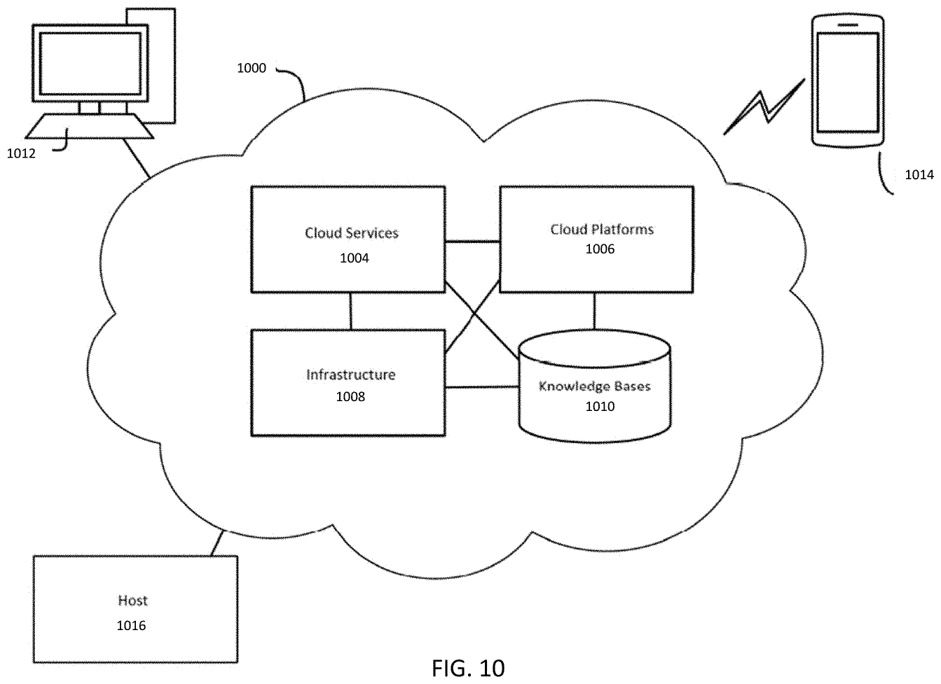

FIG. 10 shows example components of a cloud computing system 1000. By way of example and without limitation, cloud computing system 1000 may be used to perform aspects of the disclosed subject matter. Cloud-based computing generally refers to networked computer architectures where application execution, service provision, and data storage may be divided, to some extent, between clients and cloud computing devices. The “cloud” may refer to a service or a group of services accessible over a network, e.g., the Internet, by clients, server devices, and by other cloud computing systems, for example.

In one example, multiple computing devices connected to the cloud may access and use a common pool of computing power, services, applications, storage, and files. Thus, cloud computing enables a shared pool of configurable computing resources, e.g., networks, servers, storage, applications, and services, that may be provisioned and released with minimal management effort or interaction by the cloud service provider.

As an example, a cloud-based application may store copies of data and/or executable program code in the cloud computing system, while allowing client devices to download at least some of this data and program code as needed for execution at the client devices. In some examples, downloaded data and program code may be tailored to the capabilities of specific client devices, e.g., a personal computer, tablet computer, mobile phone, and/or smartphone, accessing the cloud-based application. Additionally, dividing application execution and storage between client devices and the cloud computing system allows more processing to be performed by the cloud computing system, thereby taking advantage of the cloud computing system's processing power and capability, for example.

Cloud-based computing can also refer to distributed computing architectures where data and program code for cloud-based applications are shared between one or more client devices and/or cloud computing devices on a near real-time basis. Portions of this data and program code may be dynamically delivered, as needed or otherwise, to various clients accessing the cloud-based application. Details of the cloud-based computing architecture may be largely transparent to users of client devices. By way of example and without limitation, a PC user device accessing a cloud-based application may not be aware that the PC downloads program logic and/or data from the cloud computing system, or that the PC offloads processing or storage functions to the cloud computing system, for example.

In FIG. 10, cloud computing system 1000 includes one or more cloud services 1004, one or more cloud platforms 1006, cloud infrastructure components 1008, and cloud knowledge bases 1010. Cloud computing system 1000 may include more of fewer components, and each of cloud services 1004, cloud platforms 1006, cloud infrastructure components 108, and cloud knowledge bases 1010 may include multiple computing and storage elements as well. Thus, one or more of the described functions of cloud computing system 1000 may be divided into additional functional or physical components or combined into fewer functional or physical components. In some further examples, additional functional and/or physical components may be added to the examples shown in FIG. 10. Delivery of cloud computing-based services may involve multiple cloud components communicating with each other over application programming interfaces, such as web services and multi-tier architectures, for example.

Example cloud computing system 1000 shown in FIG. 10 is a networked computing architecture. Cloud services 1004 may represent queues for handling requests from client devices. Cloud platforms 1006 may include client-interface frontends for cloud computing system 1000, such as client-interface frontends of a messaging service. Cloud platforms 1006 may be coupled to cloud services 1004 to perform functions for interacting with client devices. Cloud infrastructure 1008 may include service, billing, and other operational and infrastructure components of cloud computing system 1000. Cloud knowledge bases 1010 are configured to store data for use by cloud computing system 1000, and thus, cloud knowledge bases 1010 may be accessed by any of cloud services 1004, cloud platforms 1006, and/or cloud infrastructure components 1008.

Many different types of client devices, such as devices of users of the messaging service, may be configured to communicate with components of cloud computing system 1000 for the purpose of accessing data and executing applications provided by cloud computing system 1000. For example, a computer 1012, a mobile device 1014, and a host 1016 are shown as examples of the types of client devices that may be configured to communicate with cloud computing system 1000. Of course, more or fewer client devices may communicate with cloud computing system 1000. In addition, other types of client devices may also be configured to communicate with cloud computing system 1000 as well.

Computer 1012 shown in FIG. 10 may be any type of computing device, e.g., PC, laptop computer, tablet computer, etc., and mobile device 1014 may be any type of mobile computing device, e.g., laptop, smartphone, mobile telephone, cellular telephone, tablet computer, etc., configured to transmit and/or receive data to and/or from cloud computing system 1000. Similarly, host 1016 may be any type of computing device with a transmitter/receiver including a laptop computer, a mobile telephone, a smartphone, a tablet computer etc., which is configured to transmit/receive data to/from cloud computing system 1000.

In FIG. 10, communication links between client devices and cloud 1000 may include wired connections, such as a serial or parallel bus, Ethernet, optical connections, or other type of wired connection. Communication links may also be wireless links, such as Bluetooth, IEEE 802.11 (IEEE 802.11 may refer to IEEE 802.11-2007, IEEE 802.11n-2009, or any other IEEE 802.11 revision), CDMA, 3G, GSM, WiMAX, or other wireless based data communication links.

In other examples, the client devices may be configured to communicate with cloud computing system 1000 via wireless access points. Access points may take various forms. For example, an access point may take the form of a wireless access point (WAP) or wireless router. As another example, if a client device connects using a cellular air-interface protocol, such as CDMA, GSM, 3G, or 4G, an access point may be a base station in a cellular network that provides Internet connectivity via the cellular network.

As such, the client devices may include a wired or wireless network interface through which the client devices may connect to cloud computing system 1000 directly or via access points. As an example, the client devices may be configured to use one or more protocols such as 802.11, 802.16 (WiMAX), LTE, GSM, GPRS, CDMA, EV-DO, and/or HSPDA, among others. Furthermore, the client devices may be configured to use multiple wired and/or wireless protocols, such as “3G”, “4G” or “5G” data connectivity using a cellular communication protocol, e.g., CDMA, GSM, or WiMAX, as well as for “WiFi” connectivity using 802.11. Other types of communications interfaces and protocols could be used as well.

The above described aspects of the disclosure have been described with regard to certain examples and embodiments, which are intended to illustrate but not to limit the disclosure. It should be appreciated that the subject matter presented herein may be implemented as a computer process, a computer-controlled apparatus or a computing system or an article of manufacture, such as a computer-readable storage medium.

Those skilled in the art will also appreciate that the subject matter described herein may be practiced on or in conjunction with other computer system configurations beyond those described herein, including multiprocessor systems, microprocessor-based or programmable consumer electronics, minicomputers, mainframe computers, handheld computers, personal digital assistants, e-readers, cellular telephone devices, biometric devices, mobile computing devices, special-purposed hardware devices, network appliances, and the like. The embodiments described herein may also be practiced in distributed computing environments, where tasks are performed by remote processing devices that are linked through a communications network. In a distributed computing environment, program modules may be located in both local and remote memory storage devices.

A number of different types of computing devices may be used singly or in combination to implement the resources and services in different embodiments, including general-purpose or special-purpose computer servers, storage devices, network devices, and the like. In at least some embodiments, a server or computing device that implements at least a portion of one or more of the technologies described herein, including the techniques to implement the functionality of aspects discussed herein.

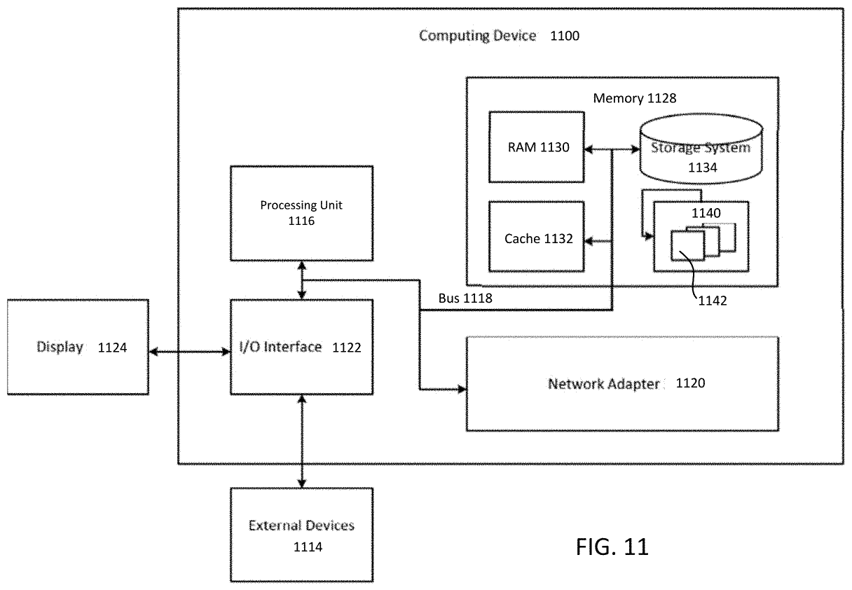

FIG. 11 shows such a general-purpose computing device 1100. The computing device 1100 may operate in a virtual environment, such as the environment 1000 in FIG. 10. Computing device 1100 may be used to host the messaging service or the messaging application. Computing device 1100 may be configured to communicate with devices of users of the messaging application. Computing device 1100 may be a general-purpose computing device. Computing device 1100 may be an on-premises device, such as a node of a distributed system running in a user's data center. The components of computing device 1100 may include, but are not limited to, one or more processors or processing units 1116, a system memory 1128, and a bus 1118 that couples various system components including system memory 1128 to processor 1116.

The bus 1118 in the example of FIG. 11 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA′) bus, Micro Channel Architecture (MCA′) bus, Enhanced ISA (EISA′) bus, Video Electronics Standards Association (VESA′) local bus, and Peripheral Component Interconnects (‘PCI’) bus.

Computing device 1100 may include a variety of computer system readable media. Such media may be any available media that is accessible by computing device 1100, and it includes both volatile and non-volatile media, removable and non-removable media. Computing device 1100 may include system memory 1128, which may include computer system readable media in the form of volatile memory, such as random access memory (‘RAM’) 1130 and/or cache memory 1132. Computing device 1100 may further include other removable/non-removable, volatile/non-volatile computer system storage media. By way of example only, a storage system 1134 may be provided for reading from and writing to a non-removable, non-volatile magnetic media (not shown and typically called a “hard drive”). Although not shown, a magnetic disk drive for reading from and writing to a removable, non-volatile magnetic disk, e.g., a “floppy disk,” and an optical disk drive for reading from or writing to a removable, non-volatile optical disk such as a CD-ROM, DVD-ROM or other optical media may be provided. In such instances, each may be connected to bus 1118 by one or more data media interfaces. As will be further depicted and described below, memory 1128 may include at least one program product having a set, e.g., at least one, of program modules that are configured to carry out the functions of embodiments of the invention.

Computing device 1100 may include a program/utility 1140 having a set (at least one) of program modules 1142 that may be stored in memory 1128. Computing device 1100 of FIG. 11 may also include an operating system, one or more messaging application programs, other messaging application program modules, and messaging application program data. Each of the operating system, one or more messaging application programs, other messaging application program modules, and messaging application program data or some combination thereof, may include an implementation of a networking environment, such as the cloud computing system 1000 in FIG. 1. Program modules 1142 generally carry out the functions and/or methodologies of embodiments of the invention as described herein.

Computing device 1100 of FIG. 11 may also communicate with one or more external devices 1114 such as a keyboard, a pointing device, a display 1124, and so on that enable a user to interact with computing device 1100. Computing device 1100 may also include any devices, e.g., network card, modem, etc., that enable computing device 1100 to communicate with one or more other computing devices. Such communication may occur, for example, via I/O interfaces 1121. Still yet, computing device 1100 may communicate with one or more networks such as a local area network (LAM), a general wide area network (WAN′), and/or a public network, e.g., the Internet, via network adapter 1120. As depicted, network adapter 1120 communicates with the other components of computing device 1100 via bus 1118. It should be understood that although not shown, other hardware and/or software components could be used in conjunction with computing device 1100. Examples include, but are not limited to, microcode, device drivers, redundant processing units, external disk drive arrays, RAID systems, tape drives, and data archival storage systems, and so on.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from, or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

The present invention also relates to an apparatus or system for performing the operations described herein. This apparatus or system may be specifically constructed for the required purposes, or the apparatus or system can comprise a general-purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general-purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

1. A system for generating gaming offers, comprising:
a first application operating on a first computing device, the application configured to receive, via a user interface, player information comprising a set of anticipated play information associated with a user;
a second application operating on a second computing device, the second application configured to receive information indicative of one or more potential offers each associated with a merchant and a set of rules, wherein each rule is indicative of an offer requirement;
a secure cloud database storing player information, for at least one user, a player history, an offer history, the one or more potential offers, and rules associated with one or more merchants;
a rules engine configured to generate one or more offers to incentivize gameplay based on the player information;
a management platform in remote network communication with the first application and the second application, the management platform comprising a processor in communication with at least one memory, the memory comprising instructions that cause the processor to at least:
receive, from the first application, the player information, including the set of anticipated play information associated with a user;
receive, from the second application, the one or more potential offers;
determine, at the rules engine, a subset of applicable rules satisfied by the player information and the set of anticipated play information;
generate, at the rules engine, an offer listing based on the subset of applicable rules and the one or more potential offers, wherein the offer listing comprises an offer redeemable at a merchant location;
provide the offer listing at the first application via the user interface; and
in response to a receiving a selection of an offer from the first application, activate, via the second application, the selected offer for redemption at the merchant location.

2. The system of claim 1, wherein the offer provides a free play amount for redemption at the merchant location.

3. The system of claim 2, wherein the location is a physical location or an online gaming platform.

4. The system of claim 1, wherein the anticipated play information comprises at least one of: a type of game, a frequency of play, a preferred type of play, a budget, a date of play, and a time of play.

5. The system of claim 4, wherein the preferred type of play is based on a budget or a time range for play.

6. The system of claim 1, wherein a subset of the offer rules are defined by the merchant.

7. The system of claim 1, wherein the memory further comprises instructions that cause the processor to at least:
determine that the offer was redeemed; and
update the player information with redemption information.

8. The system of claim 1, wherein the memory further comprises instructions that cause the processor to at least:
determine a player rating based on the player information; and
update the subset of applicable rules based on the player rating.

9. The system of claim 1, wherein the offer is redeemable via at least one of:
a QR code, an alphanumeric code, an email, a text message, a printable coupon, and an update to a player account associated with the merchant.

10. A method for generating gaming offers, comprising:
receiving, via a user interface of a first application operating on a computing device, player information, including a set of anticipated play information associated with a user;
receiving, via a second application operating on a second computing device, information indicative of one or more potential offers, each associated with a merchant and a set of rules, wherein each rule is indicative of an offer requirement;
determining, at a rules engine configured to generate one or more offers, a subset of applicable rules satisfied by the player information and the set of anticipated play information;
generating, at the rules engine, an offer listing based on the subset of applicable rules and the one or more potential offers, wherein the offer listing comprises an offer redeemable at a merchant location;
providing the offer listing at the first application via the user interface; and
in response to receiving a selection of an offer from the first application, activate, via the second application, the selected offer for redemption at the merchant location.

11. The method of claim 10, wherein the anticipated play information comprises an anticipated budget, and at least one rule in the set of applicable rules provides a free play amount based on the anticipated budget.

12. The method of claim 10, wherein the player information includes a player rating, and at least one rule in the set of applicable rules provides a free play amount based on the player rating.

13. The method of claim 12, wherein the player rating is based on at least one of: a player history, an offer redemption history, an amount spent, and criteria set by the merchant.

14. The method of claim 10, further comprising redeeming the offer at a physical location or an online gaming platform.

15. The method of claim 10, wherein the offer is redeemable via at least one of: a QR code, an alphanumeric code, an email, a text message, a printable coupon, and an update to a player account associated with the merchant.

16. The method of claim 10, wherein the anticipated play information comprises at least one of: a type of game, a frequency of play, a preferred type of play, a budget, a date of play, and a time of play.

17. The method of claim 10, wherein a subset of the offer rules are defined by the merchant.

18. The method of claim 10, further comprising generating a second offer for a second merchant.

19. The method of claim 10, wherein at least one applicable rule determines a free play amount based on player history with the merchant.

20. A computer-implemented system for generating gaming offers, comprising:
receiving, via a user interface of a first application operating on a computing device, player information, including a set of anticipated play information associated with a user;
receiving, via a second application operating on a second computing device, information indicative of one or more potential offers, each associated with a merchant and a set of rules, wherein each rule is indicative of an offer requirement;
determining, at a rules engine configured to generate one or more offers, a subset of applicable rules satisfied by the player information and the set of anticipated play information;
generating, at the rules engine, an offer listing based on the subset of applicable rules and the one or more potential offers, wherein the offer listing comprises and offer redeemable at a merchant location;
providing the offer listing at the first application via the user interface; and
in response to receiving a selection of an offer from the first application, activate, via the second application, the selected offer for redemption at the merchant location.
